(19) United States
(12) Patent Application Publication
(10) Pub. No.: US 2011/0235856 A1
(43) Pub. Date: Sep. 29, 2011

(54) METHOD AND SYSTEM FOR COMPOSING AN IMAGE BASED ON MULTIPLE CAPTURED IMAGES

(76) Inventors: Naushirwan Patuck, Cambridge (GB); Peter Francis Chevalley De Rivas, Cambridge (GB)

(21) Appl. No.: 12/758,899

(22) Filed: Apr. 13, 2010

Related U.S. Application Data
(60) Provisional application No. 61/316,865, filed on Mar. 24, 2010.

(51) Int. Cl. G06K 9/00

(52) U.S. Cl. 382/103

(57) ABSTRACT

A mobile multimedia device may be operable to capture consecutive image samples of a scene. The scene may comprise one or more objects such as faces or moving objects which may be identifiable by the mobile multimedia device. An image of the scene may be created by the mobile multimedia device utilizing a plurality of the captured consecutive image samples based on the identifiable objects. The image of the scene may be composed by selecting at least a portion of the captured consecutive image samples based on the identified one or more smiling faces. The image of the scene may be composed in such a way that the identified moving object, which may occur in the scene, may be eliminated from the composed image of the scene.

### CROSS-REFERENCE TO RELATED APPLICATIONS/INCORPORATION BY REFERENCE

This patent application makes reference to, claims priority to, and claims benefit from U.S. Provisional Application Ser. No. 61/316,865, which was filed on Mar. 24, 2010.

The above stated application is hereby incorporated herein by reference in its entirety.

### FIELD OF THE INVENTION

Certain embodiments of the invention relate to communication systems. More specifically, certain embodiments of the invention relate to a method and system for composing an image based on multiple captured images.

### BACKGROUND OF THE INVENTION

Image and video capabilities may be incorporated into a wide range of devices such as, for example, mobile phones, digital televisions, digital direct broadcast systems, digital recording devices, gaming consoles and the like. Mobile phones with built-in cameras, or camera phones, have become prevalent in the mobile phone market, due to the low cost of CMOS image sensors and the ever increasing customer demand for more advanced mobile phones with image and video capabilities. As camera phones have become more widespread, their usefulness has been demonstrated in many applications, such as casual photography, but have also been utilized in more serious applications such as crime prevention, recording crimes as they occur, and news reporting.

Historically, the resolution of camera phones has been limited in comparison to typical digital cameras, due to the fact that they must be integrated into the small package of a mobile handset, limiting both the image sensor and lens size. In addition, because of the stringent power requirements of mobile handsets, large image sensors with advanced processing have been difficult to incorporate. However, due to advancements in image sensors, multimedia processors, and lens technology, the resolution of camera phones has steadily improved rivaling that of many digital cameras.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for composing an image based on multiple captured images, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary mobile multimedia system that is operable to compose an image based on multiple captured image samples, in accordance with an embodiment of the invention.

FIG. 2 is a block diagram illustrating an exemplary image of a scene that is composed based on smiling faces in captured image samples, in accordance with an embodiment of the invention.

FIG. 3 is a block diagram illustrating an exemplary image of a scene that is composed based on a moving object in captured image samples, in accordance with an embodiment of the invention.

FIG. 4 is a flow chart illustrating exemplary steps for composing an image based on multiple captured image samples, in accordance with an embodiment of the invention.

FIG. 5 is a flow chart illustrating exemplary steps for composing an image based on selected image samples from among multiple captured image samples, in accordance with an embodiment of the invention.

### DETAILED DESCRIPTION OF THE INVENTION

Certain embodiments of the invention can be found in a method and system for composing an image based on multiple captured images. In various embodiments of the invention, a mobile multimedia device may be operable to capture consecutive image samples of a scene, where the scene may comprise one or more objects that may be identifiable by the mobile multimedia device. An image of the scene may be created by the mobile multimedia device utilizing a plurality of the captured consecutive image samples based on the identifiable objects. In an exemplary embodiment of the invention, the identifiable objects may comprise one or more faces in the scene. The mobile multimedia device may be operable to identify the faces for each of the captured consecutive image samples utilizing face detection. In an exemplary embodiment of the invention, one or more smiling faces among the identified faces for each of the captured consecutive image samples may then be identified by the mobile multimedia device utilizing smile detection. At least a portion of the captured consecutive image samples may be selected by the mobile multimedia device based on the identified one or more smiling faces. The image of the scene may be composed utilizing the selected at least a portion of the captured consecutive image samples. In this instance, for example, the image of the scene may be composed in such a way that it comprises each of the identified smiling faces which may occur in the scene during a period of capturing the consecutive image samples.

In another exemplary embodiment of the invention, the identifiable object may comprise a moving object in the scene. The mobile multimedia device may be operable to identify the moving object for each of the captured consecutive image samples utilizing a motion detection circuit in the mobile multimedia device. The image of the scene may be composed by selecting at least a portion of the captured consecutive image samples based on the identified moving object. In this instance, for example, the image of the scene may be composed in such a way that the identified moving object, which may occur in the scene during a period of capturing the consecutive image samples, may be eliminated from the composed image of the scene.

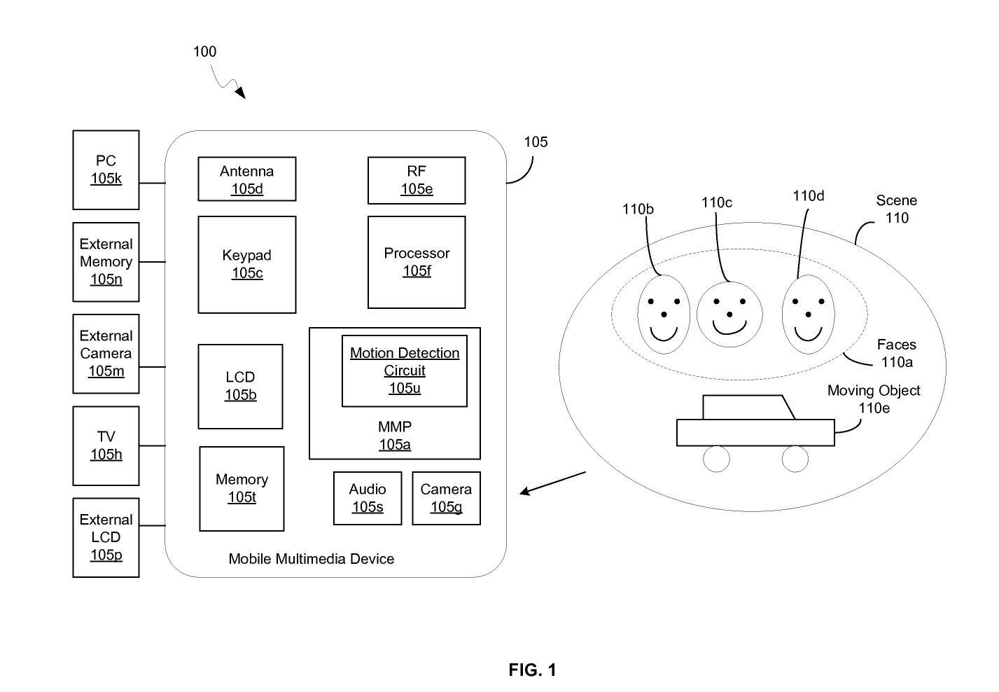

FIG. 1 is a block diagram illustrating an exemplary mobile multimedia system that is operable to compose an image based on multiple captured image samples, in accordance with an embodiment of the invention. Referring to FIG. 1, there is shown a mobile multimedia system 100. The mobile multimedia system 100 may comprise a mobile multimedia device 105, a TV 105h, a PC 105k, an external camera 105m, an external memory 105n, an external LCD display 105p and a scene 110. The mobile multimedia device 105 may be a mobile phone or other handheld communication device.

The mobile multimedia device 105 may comprise suitable logic, circuitry, interfaces and/or code that may be operable to communicate radio signals across a wireless communication network. The mobile multimedia device 105 may be operable to process image, video and/or multimedia data. The mobile multimedia device 105 may comprise a mobile multimedia processor (MMP) 105a, a memory 105t, a processor 105f, an antenna 105d, an audio block 105s, a radio frequency (RF) block 105e, an LCD display 105b, a keypad 105c and a camera 105g.

The mobile multimedia processor (MMP) 105a may comprise suitable logic, circuitry, interfaces, and/or code that may be operable to perform image, video and/or multimedia processing for the mobile multimedia device 105. For example, the MMP 105a may be designed and optimized for video record/playback, mobile TV and 3D mobile gaming. The MMP 105a may perform a plurality of image processing techniques such as, for example, filtering, demosaic, lens shading correction, defective pixel correction, white balance, image compensation, Bayer interpolation, color transformation and post filtering. The MMP 105a may also comprise integrated interfaces, which may be utilized to support one or more external devices coupled to the mobile multimedia device 105. For example, the MMP 105a may support connections to a TV 105h, an external camera 105m, and an external LCD display 105p. The MMP 105a may be communicatively coupled to the memory 105t and/or the external memory 105n. In an exemplary embodiment of the invention, the MMP 105a may be operable to create or compose an image of the scene 110 utilizing a plurality of consecutive image samples of the scene 110 based on one or more identifiable objects in the scene 110. The identifiable objects may comprise, for example, the faces 110a and/or the moving objects 110e. The MMP 105a may comprise a motion detection circuit 105u.

The motion detection circuit 105u may comprise suitable logic, circuitry, interfaces and/or code that may be operable to detect a moving object such as, for example, the moving object 110e in the scene 110. The motion detection may be achieved by comparing the current image with a reference image and counting the number of different pixels.

The processor 105f may comprise suitable logic, circuitry, interfaces, and/or code that may be operable to control operations and processes in the mobile multimedia device 105. The processor 105f may be operable to process signals from the RF block 105e and/or the MMP 105a.

The memory 105t may comprise suitable logic, circuitry, interfaces and/or code that may be operable to store information such as executable instructions, data and/or database that may be utilized by the processor 105f and the multimedia processor 105a. The memory 105t may comprise RAM, ROM, low latency nonvolatile memory such as flash memory and/or other suitable electronic data storage.

In operation, the mobile multimedia device 105 may receive RF signals via the antenna 105d. Received RF signals may be processed by the RF block 105e and the RF signals may be further processed by the processor 105f. Audio and/or video data may be received from the external camera 105m, and image data may be received via the integrated camera 105g. During processing, the MMP 105a may utilize the external memory 105n for storing of processed data. Processed audio data may be communicated to the audio block 105s and processed video data may be communicated to the LCD 105b, the external LCD 105p and/or the TV 105h, for example. The keypad 105c may be utilized for communicating processing commands and/or other data, which may be required for image, audio or video data processing by the MMP 105a.

In an exemplary embodiment of the invention, the camera 105g may be operable to capture a plurality of consecutive image samples of the scene 110 from a viewing position, where the scene 110 may comprise one or more objects such as, for example, the faces 110a and/or the moving object 110e that may be identifiable by the MMP 105a. The captured consecutive image samples may be processed by the MMP 105a. An image of the scene 110 may be created or composed by the MMP 105a utilizing at least a portion of the image samples from a plurality of the captured consecutive image samples based on the identifiable objects such as the faces 110a and/or the moving object 110e. In instances when the identifiable objects may comprise one or more faces 110a in the scene 110, the MMP 105a may be operable to identify the faces 110a for each of the captured consecutive image samples employing face detection. The face detection may determine the locations and sizes of the faces 110a such as human faces in arbitrary images. The face detection may detect facial features and ignore other items and/or features, such as buildings, trees and bodies. One or more smiling faces 110b-110d among the identified faces 110a on a plurality of the captured consecutive image samples may then be identified by the MMP 105a employing smile detection. The smile detection may detect open eyes and upturned mouth associated with a smiling face such as the smiling face 110b on the scene 110. The image of the scene 110 may be composed by selecting at least a portion of one or more of the plurality of the captured consecutive image samples based on the identified one or more smiling faces 110b-110d. In this instance, for example, the image of the scene 110 may be composed in such a way that it comprises each of the identified smiling faces 110b-110d which may occur in the scene 110 during the period when the consecutive image samples are captured.

In instances when the identifiable object may comprise a moving object 110e in the scene 110, for example, the MMP 105a may be operable to identify the moving object 110e on at least a portion of the plurality of the captured consecutive image samples utilizing, for example, the motion detection circuit 105u in the MMP 105a. The image of the scene 110 may be composed by selecting at least a portion of the plurality of the captured consecutive image samples based on the identified moving object 110e. In this instance, for example, the image of the scene 110 may be composed in such a way that the identified moving object 110e, which may occur in the scene 110 during the period when the consecutive image samples are captured, may be eliminated from the composed image of the scene 110.

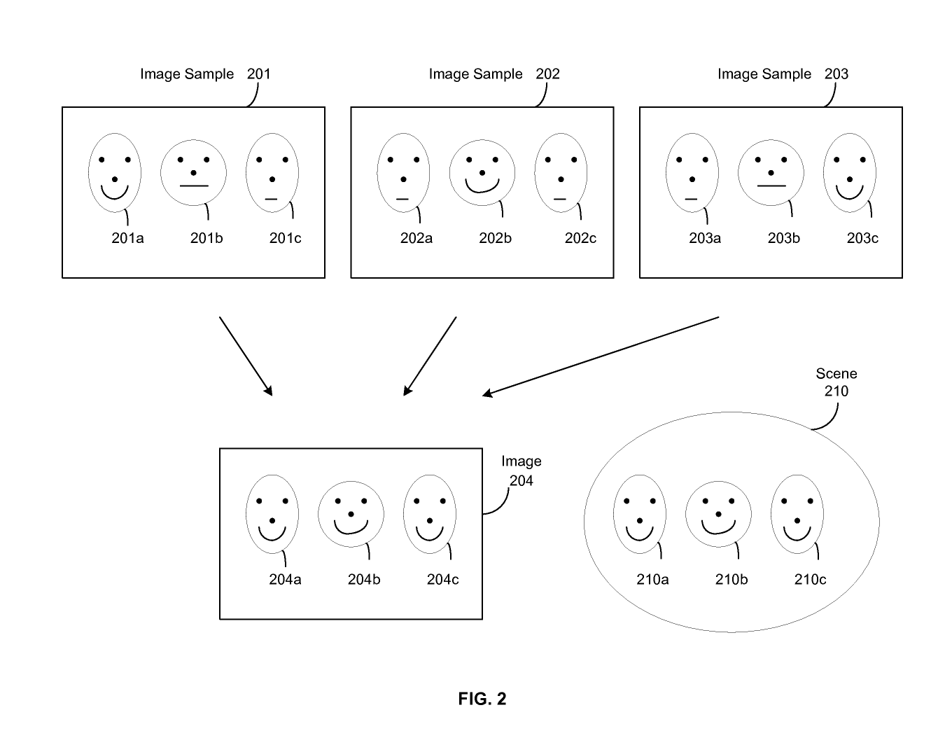

FIG. 2 is a block diagram illustrating an exemplary image of a scene that is composed based on smiling faces in captured image samples, in accordance with an embodiment of the invention. Referring to FIG. 2, there is shown a plurality of consecutive image samples of a scene such as the scene 210, of which image samples 201, 202, 203 are illustrated and an image 204 of the scene 210. The scene 210 may comprise a plurality of faces, of which the faces 210a, 210b, 210c are illustrated. The image 204 may be composed based on two or more of the image samples 201, 202, 203. The image sample 201 may comprise a plurality of faces, of which a smiling face 201a and two faces 201b, 201c are illustrated. The image sample 202 may comprise a plurality of faces, of which a smiling face 202b and two faces 202a, 202c are illustrated. The image sample 203 may comprise a plurality of faces, of which a smiling face 203c and two faces 203a, 203c are illustrated. The image 204 may comprise a plurality of faces, of which three smiling faces 204a, 204b, 204c are illustrated.

The consecutive image samples 201, 202 203 may be captured by the camera 105g at a viewing position. During the period when the consecutive image samples 201, 202, 203 are captured, the smiling face 201a is captured in the image sample 201, the smiling face 202b is captured in the image sample 202 and the smiling face 203c is captured in the image sample 203, for example. In an exemplary embodiment of the invention, the MMP 105a may be operable to identify the faces 201a-201c on the image sample 201, the faces 202a-202c on the image sample 202 and the faces 203a-203c on the image sample 203 respectively employing the face detection. The smiling face 201a among the faces 201a-201c on the image sample 201, the smiling face 202b among the faces 202a-202c on the image sample 202 and the smiling face 203c among the faces 203a-203c on the image sample 203 may then be identified respectively by the MMP 105a employing the smile detection. The image 204 of the scene 210 may be composed by selecting at least a portion of the plurality of the captured consecutive image samples 201, 202, 203 based on the identified smiling faces 201a, 202b, 203c. For example, the image 204 of the scene 210 may be composed in such a way that it may comprise two or more of the smiling faces 204a, 204b, 204c. The smiling face 204a may be extracted from the smiling face 201a on the image sample 201, the smiling face 204b may be extracted from the smiling face 202b on the image sample 202 and the smiling face 204c may be extracted from the smiling face 203c on the image sample 203. In some embodiments of the invention, it may be determined that one or more of the captured image samples should not be used. In this regard, those captured image samples that should not be utilized may be discarded and the remaining captured image samples may be utilized to create the image 204. For example, the image sample 202 for smiling face 202b may be discarded and image samples 201 and 203 may be utilized to generate or compose the image 204.

In the exemplary embodiment of the invention illustrated in FIG. 2, three faces 210a-210c in the scene 210 are shown, three image samples 201, 202, 203 are shown, three faces on an image sample such as the faces 201a-201c on the image sample 201 are shown, and one smiling face on an image sample such as the smiling face 201a on the image sample 201 is shown. Notwithstanding, the invention is not so limited and the number of the image samples, the number of the faces and the number of the smiling faces may be different.

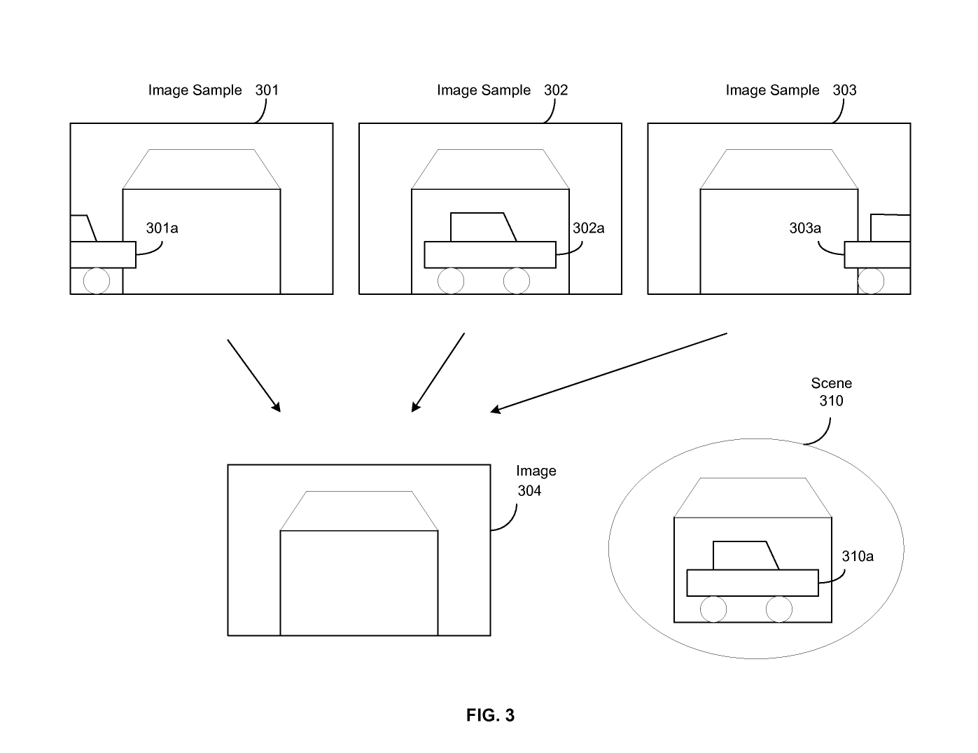

FIG. 3 is a block diagram illustrating an exemplary image of a scene that is composed based on a moving object in captured image samples, in accordance with an embodiment of the invention. Referring to FIG. 3, there is shown a plurality of consecutive image samples of a scene such as the scene 310, of which image samples 301, 302, 303 are illustrated and an image 304 of the scene 310. The scene 310 may comprise a moving object 310a. The image 304 may be composed based on two or more of the image samples 301, 302, 303. The image sample 301 may comprise a moving object 301a. The image sample 302 may comprise a moving object 302a. The image sample 303 may comprise a moving object 303a.

The consecutive image samples 301, 302 303 may be captured by the camera 105g at a position or particular viewing angle. During the period when the consecutive image samples 301, 302, 303 are captured, the moving object 301a is captured in the image sample 301, the moving object 302a is captured in the image sample 302 and the moving object 303a is captured in the image sample 303, for example. In an exemplary embodiment of the invention, the MMP 105a may be operable to identify the moving object 301a on the image sample 301, the moving object 302a on the image 302 and the moving object 303a on the image sample 303 respectively utilizing the motion detection circuit 105u in the MMP 105a. The image 304 of the scene 310 may be composed by selecting at least a portion of the image samples from a plurality of the captured consecutive image samples 301, 302, 303 based on the identified moving objects 301a, 302a, and 303a. For example, the image 304 of the scene 110 may be composed in such a way that it does not comprise the identified moving objects 301a, 302a, 303a which may occur in the scene 110 during the period when the consecutive image samples 301, 302, 303 are captured.

In the exemplary embodiment of the invention illustrated in FIG. 3, one moving object 310a in the scene 310 is shown, three image samples 301, 302, 303 are shown and one moving object on an image sample such as the moving object 302a on the image sample 302 is shown. Notwithstanding, the invention is not so limited and the number of the image samples and the number of the moving objects may be different.

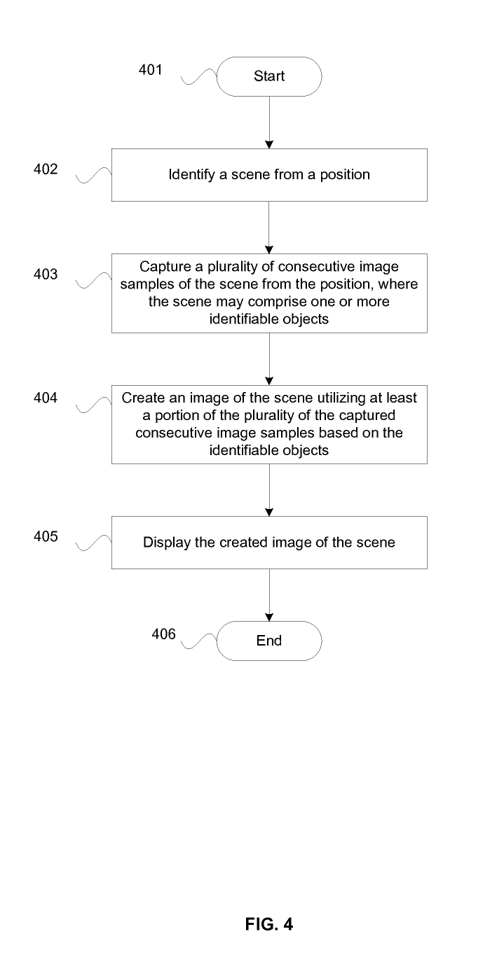

FIG. 4 is a flow chart illustrating exemplary steps for composing an image based on multiple captured image samples, in accordance with an embodiment of the invention. Referring to FIG. 4, the exemplary steps start at step 401. In step 402, the mobile multimedia device 105 may be operable to identify a scene 110 from a position or particular viewing angle. In step 403, the camera 105g in the mobile multimedia device 105 may be operable to capture a plurality of consecutive image samples 201, 202, 203, of the scene 210 from the position or viewing angle, where the scene 210 may comprise one or more identifiable objects such as the faces 210a-210c. In step 404, the MMP 105a in the mobile multimedia device 105 may be operable to create an image 204 of the scene 210 utilizing at least a portion of the plurality of the captured consecutive image samples 201, 202, 203, based on the identifiable objects. In step 405, the LCD 105b in the mobile multimedia device 105 may be operable to display the created or composed image 204 of the scene 210. The exemplary steps may proceed to the end step 406.

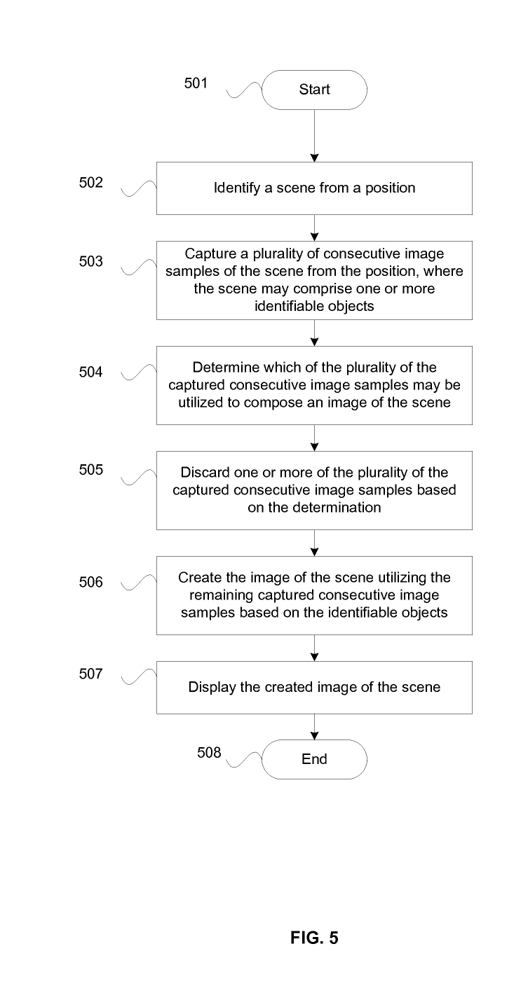

FIG. 5 is a flow chart illustrating exemplary steps for composing an image based on selected image samples from among multiple captured image samples, in accordance with an embodiment of the invention. Referring to FIG. 5, the exemplary steps start at step 501. In step 502, the mobile multimedia device 105 may be operable to identify a scene 110 from a position or particular viewing angle. In step 503, the camera 105g in the mobile multimedia device 105 may be operable to capture a plurality of consecutive image samples 201, 202, 203 of the scene 210 from the position or viewing angle, where the scene 210 may comprise one or more identifiable objects such as the faces 210a-210c. In step 504, the MMP 105a in the mobile multimedia device 105 may be operable to determine which of the plurality of the captured consecutive image samples 201, 202, 203 may be utilized to compose a final image 204 of the scene 210. The determination may be based on, for example, image quality, and/or the quality of the identifiable objects.

In step 505, the MMP 105a in the mobile multimedia device 105 may be operable to discard one or more of the plurality of the captured consecutive image samples 201, 202, 203 based on the determination. For example, the captured image sample 202 may be discarded. In step 506, the remaining captured consecutive image samples 201, 203 may be utilized to create the image 204 by the MMP 105a based on the identifiable objects. In some embodiments of the invention, in instances where the captured image sample 202 is discarded, the captured image sample may be replaced by an interpolated picture or repeated picture. In step 507, the LCD 105b in the mobile multimedia device 105 may be operable to display the created or composed image 204 of the scene 210. The exemplary steps may proceed to the end step 508.

In various embodiments of the invention, a camera 105g in a mobile multimedia device 105 may be operable to capture consecutive image samples such as image samples 201, 202, 203 of a scene 210, where the scene 210 may comprise one or more identifiable objects, which may be identified by the MMP 105a in the mobile multimedia device 105. An image such as the image 204 of the scene 210 may be created by the MMP 105a in the mobile multimedia device 105 utilizing a plurality of the captured consecutive image samples 201, 202, 203 based on the identifiable objects. In instances when the identifiable objects may comprise one or more faces 210a-210c in the scene 210, the MMP 105a in the mobile multimedia device 105 may be operable to identify the faces such as the faces 201a-201c for a captured image samples such as the image sample 201 utilizing face detection. One or more smiling faces such as the smiling face 201a among the identified faces such as the faces 201a-201c for a captured image sample such as the image sample 201 may then be identified by the MMP 105a in the mobile multimedia device 105 utilizing smile detection. At least a portion of the captured consecutive image samples 201, 202, 203 may be selected by the MMP 105a based on the identified one or more smiling faces 201a, 202b, 203c. The image 204 of the scene 210 may be composed utilizing the selected at least a portion of the captured consecutive image samples 201, 202, 203 based on the identified one or more smiling faces 201a, 202b, 203c. In this instance, for example, the image 204 of the scene 210 may be composed in such a way that it comprises each of the identified smiling faces 210a, 210b, 210c which may occur in the scene 210 during a period of capturing the consecutive image samples 201, 202, 203.

In instances when the identifiable object may comprise a moving object 310a in the scene 310, for example, the MMP 105a in the mobile multimedia device 105 may be operable to identify the moving object such as the moving object 301a for a captured consecutive image samples such as the image sample 301 utilizing a motion detection circuit 105u in the MMP 105a. The image 304 of the scene 310 may be composed by selecting at least a portion of the captured consecutive image samples 301, 302, 303 based on the identified moving objects 301a, 302a, 303a. In this instance, for example, the image 304 of the scene 310 may be composed in such a way that the identified moving object 310a, which may occur in the scene 310 during a period of capturing the consecutive image samples 301, 302, 303, may be eliminated from the composed image 304 of the scene 310.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for composing an image based on multiple captured images.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing images, the method comprising:
in a mobile multimedia device:
capturing consecutive image samples of a scene, wherein said scene comprises one or more objects that are identifiable by said mobile multimedia device; and
creating an image of said scene utilizing a plurality of said captured consecutive image samples based on said one or more identifiable objects.

2. The method according to claim 1, wherein said scene comprises one or more faces as said identifiable objects.

3. The method according to claim 2, comprising identifying said one or more faces for each of said captured consecutive image samples utilizing face detection.

4. The method according to claim 3, comprising identifying one or more smiling faces among said identified one or more faces for each of said captured consecutive image samples utilizing smile detection.

5. The method according to claim 4, comprising selecting at least a portion of said captured consecutive image samples based on said identified one or more smiling faces.

6. The method according to claim 5, comprising composing said image of said scene utilizing said selected at least a portion of said captured consecutive image samples.

7. The method according to claim 1, wherein said scene comprises a moving object as said identifiable object.

8. The method according to claim 7, comprising identifying said moving object for each of said captured consecutive image samples utilizing a motion detection circuit.

9. The method according to claim 8, comprising composing said image of said scene by selecting at least a portion of said captured consecutive image samples based on said identified moving object.

10. The method according to claim 9, comprising eliminating said identified moving object which occurs in said scene from said composed image of said scene.

11. A system for processing images, the system comprising:
one or more processors and/or circuits for use in a mobile multimedia device, said one or more processors and/or circuits being operable to:
capture consecutive image samples of a scene, wherein said scene comprises one or more objects that are identifiable by said mobile multimedia device; and
create an image of said scene utilizing a plurality of said captured consecutive image samples based on said one or more identifiable objects.

12. The system according to claim 11, wherein said scene comprises one or more faces as said identifiable objects.

13. The system according to claim 12, wherein said one or more processors and/or circuits are operable to identify said one or more faces for each of said captured consecutive image samples utilizing face detection.

14. The system according to claim 13, wherein said one or more processors and/or circuits are operable to identify one or more smiling faces among said identified one or more faces for each of said captured consecutive image samples utilizing smile detection.

15. The system according to claim 14, wherein said one or more processors and/or circuits are operable to select at least a portion of said captured consecutive image samples based on said identified one or more smiling faces.

16. The system according to claim 15, wherein said one or more processors and/or circuits are operable to compose said image of said scene utilizing said selected at least a portion of said captured consecutive image samples.

17. The system according to claim 11, wherein said scene comprises a moving object as said identifiable object.

18. The system according to claim 17, wherein said one or more processors and/or circuits are operable to identify said moving object for each of said captured consecutive image samples utilizing a motion detection circuit.

19. The system according to claim 18, wherein said one or more processors and/or circuits are operable to compose said image of said scene by selecting at least a portion of said captured consecutive image samples based on said identified moving object.

20. The system according to claim 19, wherein said one or more processors and/or circuits are operable to eliminate said identified moving object which occurs in said scene from said composed image of said scene.
